(19) United States
(12) Patent Application Publication
(10) Pub. No.: US 2018/0372688 A1
(43) Pub. Date: Dec. 27, 2018

(54) METHOD FOR ULTRASONIC TESTING OF AN OBJECT

(71) Applicant: CONSTELLIUM ISSOIRE, Issoire (FR)

(72) Inventors: Hervé STOPPIGLIA, Meylan (FR); Pascale POMMIER, Charnecles (FR)

(21) Appl. No.: 15/781,643

(22) PCT Filed: Dec. 2, 2016
(86) PCT No.: PCT/FR2016/053183

§ 371 Date: Jun. 5, 2018

(30) Foreign Application Priority Data
Dec. 7, 2015 (FR) 1561913

(51) Int. Cl. G01N 29/14; G01N 29/24; G01N 29/44; G01N 29/04

(52) U.S. Cl. CPC G01N 29/14; G01N 29/24; G01N 2291/106; G01N 29/043; G01N 2291/044; G01N 29/44

(57) ABSTRACT

The invention relates to a method for ultrasonic inspection of an object wherein a multi-element ultrasonic probe comprising a plurality of basic transducers is applied to the object. The method comprises: consecutive activation of the basic transducers such that when activated each transducer emits an ultrasonic wave incident on said object, following each activation of a basic transducer, acquisition, by a plurality of basic transducers, of a detection signal representative of a wave reflected by the object during propagation of said ultrasonic wave in the latter. The object is divided into points referred to as mesh points. Each acquired detection signal is subsequently used to calculate, at each mesh point, a parameter representative of the object that is to reflect an incident ultrasonic wave. The method comprises, during this calculation, a selection of a group of transducers from among the basic transducers of the probe.

### TECHNICAL DOMAIN

The technical domain of the invention is non-destructive testing of objects, particularly mechanical parts, by ultrasound. The invention is particularly applicable to the detection of defects in parts or in structures.

### PRIOR ART

Ultrasounds can be used to make non-destructive tests in the medical field and in the industrial field. One known application in industry is to check the integrity or quality of objects, so as to detect defects. The main method used is ultrasonography, the principle of which is to place a probe on the surface of an object, the probe emitting an ultrasound wave pulse from this surface. During its propagation in the object, the ultrasound wave interacts with any defects present in the object. When the wave encounters a defect, a reflected wave is formed causing the appearance of echoes that can be detected on the surface of the object, and that can be used to determine a position of one or several defects in the object.

Probes called multi-element probes formed by elementary transducers laid out side by side in a single or two-dimensional layout are currently used regularly. Each elementary transducer is formed from a piezoelectric material capable of producing and/or detecting an ultrasound wave, in a frequency range generally between 100 kHz and 50 MHz. Each elementary transducer can then be used as a transmitter and as a receiver.

When testing an object, each elementary transducer in a multi-element probe is activated in sequence so as to form a transmitter. Every time that an elementary transducer is activated, the elementary transducers of the probe are used as detectors to detect an echo from the object. If the probe comprises N elementary transducers, N detected signals are collected every time that one of these elementary transducers is activated. After having activated the N transducers of the probe successively, N² detected signals are collected, each detected signal corresponding to one transmitter/detector pair. Algorithms have been developed to determine a position of one or several defects in the object, starting from these detected signals.

This type of test is now operational. However, when the probe is applied in contact with an object to be tested, particularly a metal object, the test is affected by a zone called the dead zone extending from the surface of the object to which the probe is applied, at a shallow depth, in which the quality of the test is not optimal Also, at the present time, it is considered that a multi-element probe is not perfectly adapted to a quality test carried out on objects at a shallow depth, or in the first millimeters of the thickness of an object.

The inventors have attempted to solve this problem by improving the quality of the results obtained, particularly in the first millimeters or centimeters of the depth in an object.

### PRESENTATION OF THE INVENTION

A first purpose of the invention is a method of testing an object, particularly an industrial object, comprising the following steps:

a) application of a multi-element probe facing said object, said probe comprising a plurality of elementary transducers, each elementary transducer being capable of emitting an ultrasound wave to said object and/or of detecting an ultrasound wave reflected in said object;

b) activation of one of said elementary transducers, called the emission transducer, such that it transmits an ultrasound wave called the incident wave, to said object;

c) acquisition of a detection signal representative of a wave reflected in the object under the effect of said incident wave propagating in the object, by one or several of said elementary transducers called detection transducers, each detection signal being associated with said emission transducer and with one of said detection transducers;

d) repetition of steps b) and c) by activating several elementary transducers of the probe in sequence, so as to acquire detection signals associated with different emission transducers;

e) starting from detection signals acquired during each step c), create a mesh of the object at several points called mesh points, and at each mesh point, calculate a parameter representing an ability of the object to reflect an incident wave at said mesh point.

the method being characterized in that step e) comprises the following sub-steps:

i) selection of a number of elementary emission transducers smaller than the number or elementary transducers forming the multi-element probe, for at least one mesh point;

ii) calculate said parameter at said mesh point considering the detection signals associated with the emission transducers thus selected.

Preferably, sub-steps i) and ii) are used for each mesh point, or for each mesh point at a depth from said multi-element probe equal to less than a “limiting” depth that can be predetermined.

Preferably, during sub-step ii), the parameter at said mesh point is calculated considering only the detection signals detected by the transducers during sub-step i).

The method may comprise any one of the following characteristics, taken alone or in any technically feasible combination:
The object is a metallic object, for use particularly in an aeronautical application, it may be a parallelepiped shaped plate, or a cylinder or it may have any other shape that can be placed in contact with said multi-element probe. The invention is particularly applicable to materials in which the speed of an ultrasound wave emitted by said elementary transducers is more than 5000 m·s⁻¹ and in particular is between 5000 and 7000 m·s⁻¹.
During step i), the number of elementary transducers selected for said mesh point depends on a depth of said point relative to said multi-element probe. This depth corresponds to a distance between said point and the multi-element probe.
During step i), the number of elementary transducers selected for said mesh point depends on an average depth of a previously determined region of interest in the object.
The limiting emission angle is defined as a function of a principal emission lobe of an emission transducer. Such a lobe is present in an angular distribution of the amplitude of an ultrasound wave emitted by said emission transducer. The limiting emission angle can be determined by calculating a ratio between a speed of the wave in the object and a product of the frequency of the wave by a dimension of the transducer, this ratio corresponding to a tangent of this limiting emission angle.
The multi-element probe defines a detection plane along which the elementary transducers extend. The transducers selected in sub-step i) are included in a cone, called the selection cone, defined for each mesh point, this selection cone:
extending between a vertex corresponding to said mesh point and said detection plane, with a half-angle corresponding to the limiting emission angle;
comprising a height joining said vertex to the detection plane, this height being orthogonal to said detection plane.
The multi-element plane defines a pitch corresponding to a distance between the centers of two adjacent elementary transducers. During sub-step i), the selection is made for one mesh point or even for each mesh point, by:
estimating the limiting emission angle associated with an elementary transducer;
a determination of a depth of said mesh point related to the probe;
a determination of the elementary transducer closest to said point, called the proximal transducer;
a calculation of a product of the tangent of said emission angle and said depth;
a determination of a number of elementary transducers selected around said proximal transducer by dividing said product calculated by said pitch of said multi-element probe.
Step e) comprises the following sub-steps:
for each mesh point, determination of a path time of an incident wave emitted by an emission transducer, then reflected at said point before being detected by a detection transducer, said emission and detection transducers forming an emitter/detector pair with which said path time is associated;
for each mesh point, summation of the amplitude of each detection signal associated with an emission transducer/reception transducer pair and said path time associated with the same emitter/detector pair, so as to obtain a so-called accumulated amplitude at said point;
the cumulated amplitude, obtained at each mesh point, representing a capability of the object at said point to reflect an incident wave.
The method comprises a step f) to locate a defect in the object, starting from parameters determined at each point, during step e), and particularly from an image formed using each parameter calculated in step e).
At each mesh point, there is a corresponding depth from the multi-element probe, sub-steps i) and ii) being used for a plurality of mesh points with a depth less than a limiting depth, less than 2 cm or even less than 1 cm.
The multi-element probe is applied in contact with said surface of the object, a thin layer of a coupling fluid particularly in the form of a gel or liquid possibly being intercalated between said probe and said surface of the object, so as to improve transmission of an ultrasound wave between each elementary transducer and the object.

A second purpose of the invention is an information record support comprising instructions for execution of the method described in this application, these instructions being executable by a microprocessor.

A third purpose of the invention is a multi-element ultrasound probe comprising a plurality of elementary transducers, each elementary transducer being capable of emitting and/or detecting an ultrasound wave, said probe being characterized in that it comprises a computer, for example a microprocessor, capable of implementing the method described in this application.

The invention will be better understood after reading the detailed description of an example embodiment given below, with reference to the figures listed below.

### FIGURES

FIG. 1A represents an ultrasound wave emitted by an elementary transducer of a multi-element type probe propagating in an object. La FIG. 1B represents an ultrasound wave reflected by a defect in an object, propagating towards elementary transducers of a multi-element probe. FIG. 1C illustrates two signals detected by two adjacent elementary transducers, each signal representing detection of the reflected wave mentioned with reference to FIG. 1B. FIG. 1D shows two adjacent transducers of the multi-element probe, these transducers defining a pitch of said probe.

FIG. 2 represents the principal steps in a method of testing an object according to prior art.

FIGS. 3A and 3B show two images of a defect in the object located at depths from the multi-element probe equal to 10 mm and 3 mm respectively. The scale of grey levels is represented in the form of a horizontal bar.

FIGS. 4A and 4B show an emission diagram of elementary transducers, this diagram comprising one principal lobe and two secondary lobes. These figures represent a configuration in which, with the object being meshed at different mesh points, a mesh point of the object is not positioned in the principal lobe of an elementary transducer.

FIG. 5A represents a selection cone, associated with a mesh point of the object, under which said mesh point sees elementary transducers of the multi-element probe, in the first emission lobe in which said mesh point is located.

FIG. 5B represents selection cones associated with different mesh points of the object, distributed at different depths.

FIG. 6 represents the principal steps in a method according to the invention,

FIGS. 7A and 7B are images obtained with and without use of the method according to the invention, respectively. The scale of grey levels is represented in the form of a horizontal bar.

### DETAILED PRESENTATION OF PARTICULAR EMBODIMENTS

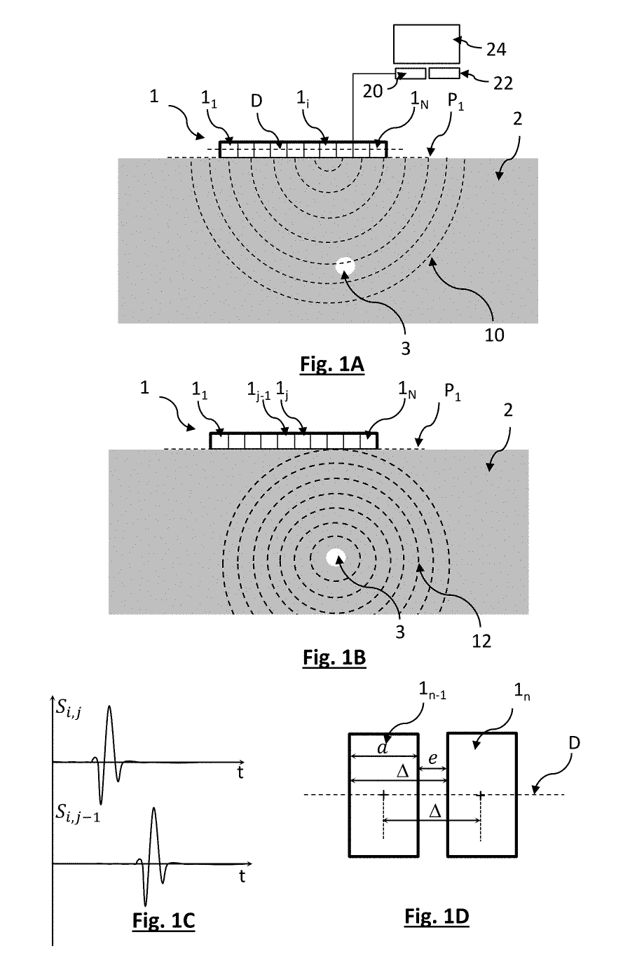

FIGS. 1A and 1B represent a multi-element ultrasound probe 1, comprising N elementary transducers 1₁ to 1_{N} placed side by side, extending along a direction D in a plane called the detection plane P₁. Each elementary transducer comprises a piezoelectric material that enables emission or detection of an ultrasound wave. The probe is put into contact with an object 2 in order to test it. In this example, the examined object is a plate formed from a first material, for example an aluminum alloy that might contain a defect 3, in this case an air cavity. The purpose of the test is to detect and to position the defect 3. In other applications, the defect might be the presence of corrosion, a local variation of porosity or, more generally, any local singularity that causes a variation of the acoustic impedance in the object. Thus in general, the object is any object intended for industrial use. In particular, it can be a metallic object.

One of the elementary transducers 1ᵢ, called the emission transducer, can be activated so as to emit an ultrasound wave 10 called the incident wave, propagating in the object 2. As indicated with reference to prior art, the frequency f of this incident wave 10 can be within the 100 kHz to 50 MHz range. Preferably, this frequency f is between 1 and 15 MHz.

In this example, it is equal to 5 MHz.

If there is a defect present in the object, a reflected ultrasound wave 12 is formed and propagates through the object, at the same frequency f as the emission wave 10. This reflected wave 12 is formed at the interface of the defect. It is due to a local variation of the acoustic impedance at this interface. The reflected wave 12 propagates towards the multi-element probe 1 and can then be detected by several elementary transducers 1ⱼ, called detection transducers, including the elementary transducer 1ᵢ that emitted the incident wave 10. In this example, there are N=64 elementary transducers. The reflected wave 12 is detected by the N elementary transducers, each forming a detection signal S_{(i,j)}, the index i designating the emission transducer and the index j designating the detection transducer.

FIG. 1C represents the signals S_{(i,j)} and S_{(i,j-1)} detected by two adjacent transducers 1₍ⱼ₎ and 1₍ⱼ₋₁₎ respectively, as a function of time. Detection of the reflected wave 12 is characterized on each of these signals by a characteristic variation of the amplitude, or detection pattern, forming a signature of the defect. The time shift of the signature between these two signals is due to the path time or the flight time of the reflected wave 12 between the defect 3 and each detection transducer.

FIG. 1D represents two adjacent transducers 1ₙ, 1ₙ₋₁. These transducers have a dimension a along a direction D in which the transducers of the multi-element probe 1 are all in line, corresponding in this case to a width. There are separated by an inter-transducer space e. The sum of the dimension a and the inter-transducer space e forms a pitch A of the multi-elements problem 1. This pitch A corresponds to a distance between the centers of two adjacent elementary transducers, or to an edge-to-edge distance between two adjacent transducers.

The multi-element probe 1 is preferably applied in contact with the object, and bears on a surface of the object called the bearing surface. This does not exclude the possible presence of a coupling fluid, particularly in the form of a gel or a liquid, intercalated between the multi-element probe 1 and the object 2, so as to improve transmission of an ultrasound wave between each elementary transducer and the object, in the case of an incident wave or a reflected wave.

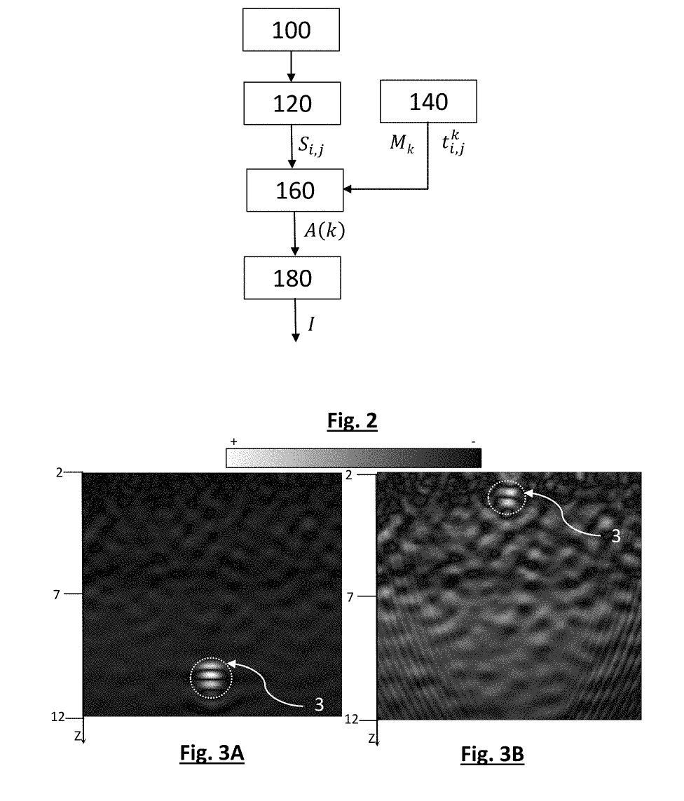

We will now describe a classical method of testing an object, with reference to FIG. 2. This method is known as FMC-TFM (Full Matrix Capture-Total Focusing Method).

In a first application step 100, the probe 1 is applied facing the object 2, and preferably in contact with one face of the object, or in contact with a shim resting on the object.

In an acquisition step 120, each transducer 1 is activated in sequence and then becomes an emission transducer. When a transducer 1ᵢ is activated, detection signals S_{i,j} detected by the N transducers of the multi-element probe 1 are acquired. Also, N detection signals S_{i,j} are acquired every time that a transducer 1ᵢ is activated. After successive activation of N elementary transducers 1₁ . . . 1_{N}, there are N² detection signals S_{i,j}, each corresponding to an emitter 1ᵢ—detector 1ⱼ pair.

In a step 140, the analyzed object 2 is discretized using a mesh comprising K mesh points Mₖ, where 1≤k≤K. For example, the index k represents a coordinate of the mesh point Mₖ in the object. At each point mesh Mₖ, it is possible to calculate a path time t_{i,j}^{k} of an acoustic wave with frequency f propagating between an emission transducer 1 and the point Mₖ, then between this point and a reception transducer 1ⱼ. Path times can be obtained for each mesh point Mₖ, considering the previously mentioned N² emitter/detector pairs. A matrix T^{k}, can then be formed for each mesh point Mₖ, where T^{k}(i,j)=t_{i,j}^{k} the dimension of this matrix being (N, N). This step to calculate each path time t_{i,j}^{k} can be performed before or after the acquisition step 120. Each path time t_{i,j}^{k} corresponds to the instant at which a wave 12, reflected following the emission of an incident wave 10 by an emission transducer 10ᵢ, reaches a detection transducer 10ⱼ, the instant at which the incident wave is emitted corresponding to instant t=0.

The next step 160, called the focusing step, consists of summating the amplitudes of signals S_{i,j} at each instant t_{i,j}^{k}, or within a time interval δt_{i,j}^{k} located around this instant, for each mesh point Mₖ. It is then possible to calculate a sum, called the coherent sum A(k), (or cumulated amplitude), of the amplitude of each signal S_{i,j} for each mesh point Mₖ at each instant t_{i,j}^{k}, such that:

A(k)=Σᵢ₌₁^{N}Σⱼ₌₁^{N}S_{i,j}(t_{i,j}^{k}) (1)

This coherent sum reflects a reflectivity of the object at each mesh point Mₖ. Reflectivity means a parameter representing the ability to form a reflected wave from an incident wave propagating in the object.

During an interpretation step 180, the amplitudes associated with the different mesh points Mₖ can be assembled to form a matrix A representing a spatial distribution of the cumulated amplitude A(k) in the object. Such a matrix can be represented in the form of a reconstruction image I, by assigning a color code to each cumulated amplitude A(k). This method can be used to detect the presence of defects 3 in the object 2 and to determine their position.

The multi-element probe 1 also comprises a calculation unit or processor 20, for example a microprocessor, capable of processing each detection signal S_{i,j} detected by the transducers 1ⱼ. In particular, the processor is a microprocessor connected to a programmable memory 22 in which a sequence of instructions is stored to perform the spectrum processing operations and calculations described in this description. These instructions can be saved on a recording support of the hard disk type, or a CDROM or another type of memory that can be read by the processor. The processor can be a display unit, 24, for example a screen.

FIGS. 3A and 3B represent images obtained making use of a multi-element ultrasound probe connected to a “Gekko” type portable acquisition system, marketed by the M2M company. In particular, this probe has 64 elementary transducers with frequency 5 MHz, with width a equal to 0.8 mm aligned along a direction D, the space e between two adjacent transducers being equal to 0.2 mm.

FIGS. 3A and 3B correspond to the result of the test of an aluminum plate comprising a 0.8 mm diameter air cavity 3 located at depths of 10 mm and de 3 mm respectively from a bearing surface in contact with which the probe 1 is placed. This cavity is obtained by forming a flat hole in the aluminum plate.

The defect 3 is detected on these two images but it appears more sharply when it is at depth (image 3A) due to a better signal-to-noise ratio. When it is at a shallow depth (image 3B), the signal-to-noise ratio is mediocre. Thus, there is a risk that a defect located at a shallow depth will not be correctly identified.

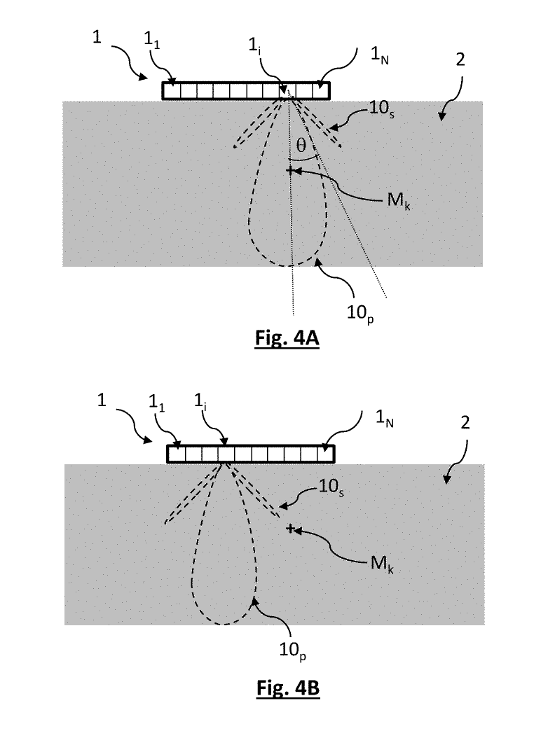

The inventors have established a link between this problem and the emission diagram of an elementary transducer. Emission of an acoustic wave by a piezoelectric transducer is not isotropic. The acoustic pressure field has one principal lobe 10ₚ and several secondary lobes 10ₛ, as can be seen on FIGS. 4A and 4B. In other words, the amplitude of an acoustic wave emitted by a transducer has a spatial distribution with one principal lobe and one or several secondary lobes.

The thickness of the principal lobe reduces as the depth from the multi-elements probe reduces. Thus, a mesh point Mₖ can be located inside the principal lobe of one elementary transducer as shown on FIG. 4A, but can be outside the principal lobe of another elementary transducer of the probe, as shown on FIG. 4B.

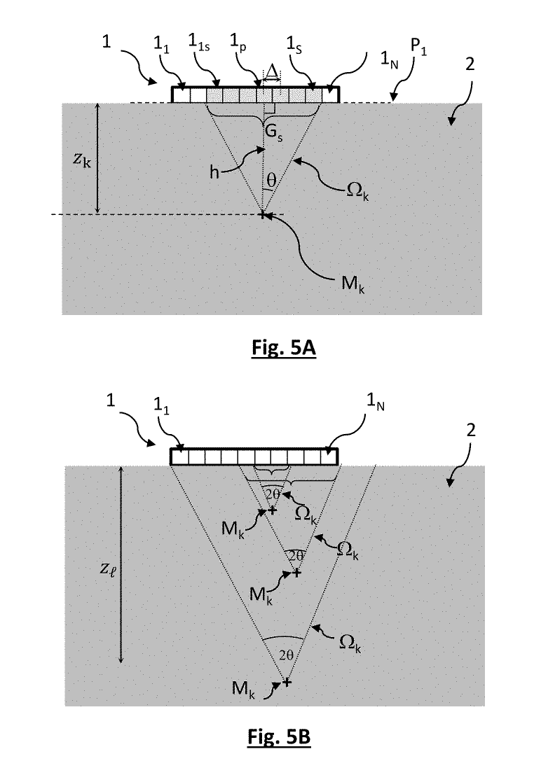

A limiting emission angle θ can be assigned to each transducer, this angle delimiting the previously mentioned principal lobe. For example, this limiting emission angle is defined by determining the position of the first local minimum on each side of the principal lobe. This limiting emission angle is shown on FIGS. 4A and 4B. Conversely, as shown on FIG. 5A, a cone Ωₖ called the selection cone, with half-angle equal to θ, can be associated with each mesh point Mₖ in the mesh of the object 2, delimiting the elementary transducers in the principal lobe in which said point Mₖ is located. One of the basic principles of the invention is then to select those transducers among the elementary transducers of the probe for which the point Mₖ is positioned in the principal lobe 10ₚ.

The limiting emission angle θ is deemed to be known, for example based on preliminary experimental tests, manufacturer data or a theoretical calculation. In this example, it is assumed that this angle θ is such that:

$$tan ( θ ) = \frac{c}{f \cdot a} , \qquad ( 2 )$$

in which
f denotes the frequency of the wave 10 emitted in the object 2;
a represents the dimension of each elementary transducer along the direction D in which the transducers extend, mentioned with reference to FIG. 1D;
c denotes an ultrasound wave in the object at the frequency of the wave emitted in the object;

Preferably, the invention is applicable to objects made of materials for which the speed c of the ultrasound wave is between 5000 and 7000 m·s⁻¹. The dimension a of each elementary transducer is generally between 0.5 mm and 2 mm.

Considering an aluminum plate (c=6200 m·s⁻¹}, a frequency f of 5 MHz and a dimension a equal to 0.8 mm, we obtain tan(θ)≈1.5. This corresponds to a limiting emission angle θ equal to about 57°.

In this example, it is assumed that the limiting emission angle θ is the same for all elementary transducers of the multi-element probe 1.

At each mesh point MₖA, a transducer called the proximal transducer 1ₚ closest to said point can be determined. A depth zₖ from the multi-element probe 1 can also be associated with each mesh point Mₖ, corresponding to the shortest distance between said point and the multi-element probe 1. Selection of the transducers consists of defining a number S of elementary transducers 1₁ₛ . . . 1ₛ extending on each side of the proximal transducer 1ₚ, such that the mesh point Mₖ is located in the principal lobe 10ₚ of each transducer thus selected. This selection can be made for all or some mesh points Mₖ of the object.

As can be seen on FIG. 5A, a selection cone Ωₖ can be associated with each mesh point Mₖ, with a vertex corresponding to point Mₖ and a half-opening angle corresponding to the limiting emission angle θ. This cone has a height h perpendicular to the plane P₁ in which the transducers extend. This height passes through the proximal transducer 1ₚ. The S selected transducers 1₁ₛ . . . 1ₛ are those that extend inside this selection cone. These transducers are shown grey on FIG. 5A. It is noted that there is a different selection cone Ωₖ corresponding to each mesh point Mₖ. The selected transducers form a selection group Gₛ, represented by a curly bracket on FIGS. 5A and 5B.

In the case of a single-dimensional probe as shown on FIG. 5A, the number of selected transistors S is such that

$$S \leq \frac{2 \cdot {z}_{k} \cdot tan ( θ )}{a + e} \qquad ( 3 )$$

In this example, tan(θ) is obtained according to (2), hence:

$$S \leq \frac{2 \cdot {z}_{k} \cdot c}{f \cdot a \cdot ( a + e )} \qquad ( 4 )$$

in which:
zₖ denotes a depth of the mesh point Mₖ in the object;
f denotes the emission frequency of the wave emitted in the object 2;
a represents the width of each elementary transducer, in this case equal to 0.8 mm;
e represents a space between two adjacent transducers, in this case equal to 0.2 mm;
the sum a+e corresponds to the pitch A of the multi-element probe, defined above,
in this case equal to 1 mm.

Thus, the number of selected transducers S may be such that:

$$S = α \frac{2 \cdot {z}_{k} \cdot c}{f \cdot a \cdot ( a + e )} \qquad ( 5 )$$

α being a reduction factor such that 0<α≤1. Preferably 0.8<α≤1, so as to maximize the number of selected transducers, to improve the reconstruction quality.

The speed of the ultrasound wave c in the object 2 depends on the nature of the material from which the object is made. This speed c is also preferably estimated on the object being examined. For example, when the object is a plate with a known thickness, the speed of the ultrasound wave emitted by a transducer can be determined by placing the probe in contact with a face of the plate and analyzing the detected signals corresponding to a wave reflected by the opposite face.

Unlike prior art, the step in the testing method to calculate the weighted sum A(k) associated with each point Mₖ includes a selection of emission transducers to be considered, as described above. The calculation of the weighted sum is made based only on signals detected after activation of the selected transducers, that are included within the selection cone Ωₖ associated with point Mₖ. Thus, the weighted sum A(k) from one mesh point to another is made using detection signals S_{i,j} corresponding to emitter/detector pairs that can be different.

As can be seen on FIG. 5B, the number S of transducers delimited by the selection cone associated with a mesh point depends on the depth zₖ of this mesh point. When the depth zₖ is less than a limiting depth zₗ, the number S of selected transducers is less than the number N of transducers in the probe. The effect of the invention is then to reduce the number of emitter/detector pairs to be considered when calculating the weighted sum A(k), considering only the transmitters, or even detectors, included in the selection cone. This is contrary to a prejudiced view according to which the quality of the measurement improves as the number of emitters-detectors increases.

Beyond said limiting depth zₗ, the selection cone Ωₖ includes all transducers in the multi-element probe and the invention has no effect for calculations made at mesh points located beyond this limiting depth. This limiting depth is obtained using equation (5) and considering S=N, namely:

$$\begin{matrix}N \approx \frac{2 \cdot {z}_{𝓁} \cdot tan ( θ )}{a + e} hence & ( 6 ) \\ {Z}_{𝓁} \approx \frac{N ( a + e )}{2 \cdot tan ( θ )} & ( 7 )\end{matrix}$$

Considering N=64, Δ=(a+e)=1 mm and tan(θ)=2.48, we obtain zₗ≈5 mm. Thus, the invention is applicable particularly to the part of the object located between the bearing surface on which the probe is placed, and the first 5 millimeters of the object. In general, the limiting depth zₗ is generally less than 3 cm, or even 2 cm, or even 1 cm.

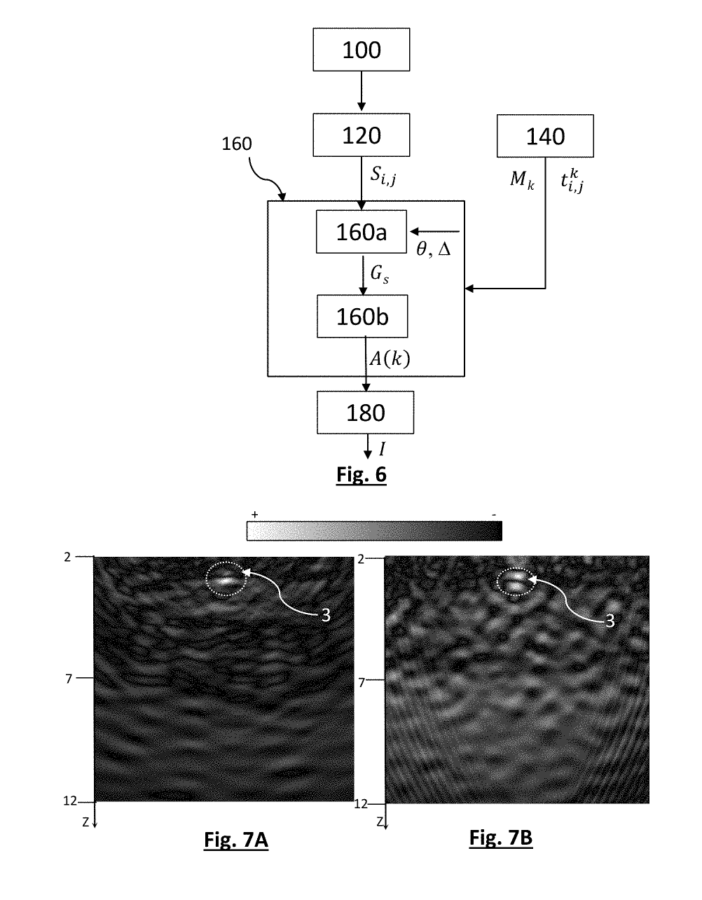

We will now describe the principal steps in a method according to the invention, with reference to FIG. 6. Steps 100, 120 and 140 are similar to steps described with reference to FIG. 2. The calculation step 160 comprises:
a sub-step 160a to select a group Gₛ of elementary transducers each mesh point Mₖ, comprising transducers located within the selection cone Ωₖ associated with said mesh point, this cone depending on the depth zₖ of this point and the limiting emission angle θ.
a calculation sub-step 160b that only considers signals S_{i,j} detected after a transducer selected in step 160a has been activated. In other words, step 160b only considers detected signals S_{i,j} corresponding to an emitter/detector pair in which the emitter, or even the detector, is one of the selected transducers.

According to one embodiment, sub-step 160b only considers signals detected by transducers selected during step 160a.

Furthermore, the cumulated amplitude A(k) calculated at each mesh point Mₖ is:

A(k)=Σᵢ₌₁ₛ^{S}Σⱼ₌₁ₛ^{S}S_{i,j}(t_{i,j}^{k}) (8)

According to another embodiment, sub-step 160b considers signals detected by all transducers forming part of the probe 1. Furthermore, the cumulated amplitude A(k) calculated at each mesh point Mₖ is:

A(k)=Σᵢ₌₁ₛ^{S}Σⱼ₌₁^{N}S_{i,j}(t_{i,j}^{k}) (9)

According to one variant, the number S of transducers is predefined and is applicable regardless of the depth zₖ of the mesh point Mₖ. It is less than the number N of elementary transducers forming the probe 1. The number of selected transducers can be determined by considering a region of interest ROI of the object, in which an increased testing precision is required. The selection is made by considering an average depth z_{ROI} of mesh points present in the region of interest. This region of interest may have been defined based on a preliminary test, or by using a method according to prior art, as described with reference to FIG. 2.

The selection step 160a may be applied to all or some of the mesh points Mₖ. When these points are located at a depth zₖ from the probe 1 less than the limiting depth zₗ mentioned above, the cumulated amplitude is calculated based on a number of emission transducers S less than the number of transducers N making up the multi-element probe.

A comparative test was carried out by testing the object described with reference to FIG. 3B, comprising a defect located at a depth of 3 mm. Firstly, a method according to prior art was used as described with reference to FIG. 2. Afterwards, a method according to the invention was used as shown on FIG. 6, by selecting 16 elementary transducers at each mesh point. FIGS. 7A and 7B show the results obtained using the invention and prior art respectively. It can be seen that FIG. 7A is less noisy than FIG. 7B, which confirms the efficiency of the invention.

Although described with reference to a single-dimensional probe in which all the transducers extend in a line, the invention is applicable to two-dimensional probes, for example matrix probes, in which the transducers are distributed in matrix form in the detection plane P₁.

Furthermore, the invention has been described for the determination of a defect in an industrial part, specifically an aluminum plate. This application is not limitative and the invention can be applied to the detection of singularities in other types of applications related to testing of industrial objects.

1. Method for testing an object for industrial purposes comprising:
a) application of a multi-element probe facing said object, said probe comprising a plurality of elementary transducers (1₁ . . . 1ₙ), each elementary transducer being capable of emitting an ultrasound wave to said object and/or of detecting an ultrasound wave reflected in said object;
b) activation of one of said elementary transducers (1ᵢ), called the emission transducer, such that it transmits an ultrasound wave called the incident wave, to said object;
c) acquisition of a detection signal (S_{i,j}) representative of a wave reflected by the object under the effect of said incident wave, by one or several of said elementary transducers (1ⱼ) called detection transducers, each detection signal being associated with said emission transducer (1ᵢ) and with one of said detection transducers (1ⱼ);
d) repetition of b) and c) by activating several elementary transducers of the probe in sequence, so as to acquire detection signals (S_{i,j}) associated with different emission transducers (1ᵢ);
e) starting from detection signals (S_{i,j}) acquired during each c), create a mesh of the object at several points (Mₖ), and at each mesh point (Mₖ), calculate a parameter (A(k)) representing an ability of the object to reflect an incident ultrasound wave at said mesh point;
wherein,
said step e) comprises the following sub-steps:
i) selection of a number (S) of emission transducers (1₁ₛ . . . 1ₛ) smaller than the number (N) or elementary transducers forming said multi-element probe (1), for at least one mesh point (Mₖ);
ii) calculate said parameter (A(k)) at said mesh point (Mₖ) considering the detection signals (S_{i,j}) associated with the emission transducers (1₁ₛ . . . 1ₛ) thus selected;
the multi-element probe defines a pitch (Δ), corresponding to a distance between the centers of two adjacent elementary transducers (1ₙ, 1ₙ₋₁), and during sub-step i), the selection is made for each mesh point Mₖ, by:
an estimate of a limiting emission angle (θ) associated with an elementary transducer (1₁), said limiting emission (θ) delimiting the principal lobe (10ₚ) in the acoustic pressure field of the elementary transducer (1₁);
a determination of a depth (zₖ) of said point from the multi-element probe;
a determination of the elementary transducer (1ₚ) closest to said point, called the proximal transducer;
a calculation of a product of the tangent of said emission angle (θ) and said depth (zₖ);
a determination of a number (S) of elementary transducers selected around said proximal transducer by dividing said product by said pitch (Δ) of said multi-element probe (1).

2. Method according to claim 1, in which the number of emission transducers (S) selected in step i) for said mesh point (Mₖ) depends on a depth (zₖ) of said point below the multi-element probe, said depth corresponding to a distance between said mesh point and said multi-element probe.

3. Test method according to claim 1, in which sub-steps i) and ii) are performed for each mesh point (Mₖ) of the object.

4. Test method according to claim 1, in which during sub-step i), the selection is made as a function of a limiting emission angle (θ), at which an emission transducer (1ᵢ) emits an incident wave (10).

5. Method according to claim 4, in which said limiting emission angle (θ) is defined as a function of a principal emission lobe (10ₚ) of an emission transducer (1ᵢ).

6. Test method according to either claim 4, in which the multi-element probe defining a detection plane (Pᵢ), in which the elementary transducers (1₁ . . . 1_{N}) extend, the transducers selected during sub-step i) are contained within a cone called the selection cone (Ωₖ), defined for each mesh point (Mₖ), this selection cone:
extending between a vertex corresponding to said mesh point (Mₖ) and the detection plane, with a half-angle corresponding to the limiting emission angle (θ);
comprising a height (h) joining said vertex to the detection plane (P₁), this height being orthogonal to said detection plane.

7. Test method according to claim 1, in which step e) comprises the following sub-steps:
for each mesh point (Mₖ), determination of a path time (t_{i,j}^{k}) of an incident wave emitted by an emission transducer (1ᵢ), then reflected at said point (Mₖ) before being detected by a detection transducer (1ᵢ), said emission and detection transducers forming an emitter/detector pair with which said path time (t_{i,j}^{k}) is associated;
for each mesh point (Mₖ), summation of an amplitude of each detection signal (S_{i,j}) associated with an emission transducer/reception transducer pair and said path time (t_{i,j}^{k}) associated with the same emitter/detector pair, so as to obtain a so-called accumulated amplitude (A(k)) such that:
$$A ( k ) = {\sum }_{i = 1}^{N} {\sum }_{j = 1}^{N} {S}_{i , j} ( {t}_{i , j}^{k} )$$
the cumulated amplitude (A(k)), obtained at each mesh point (Mₖ), representing a capability of the object at said point to reflect an incident wave.

8. Test method according to claim 1, comprising a step f) to determine the position of a defect in the object, from parameters (A(k)) determined at each point, during said step e).

9. Test method according to claim 1, in which said multi-element probe is placed in contact with said object.

10. Test method according to claim 9, in which a coupling liquid or gel is intercalated between said probe and said object, so as to improve a transmission of an ultrasound wave between each transducer and the object.

11. Test method according to claim 1, in which speed of an ultrasound wave emitted by each elementary transducer in the object is between 5000 and 7000 m·s⁻¹.

12. Test method according to claim 1, in which for each mesh point, there is a depth (zₖ) from the multi-element probe (1), and in which sub-steps i) and ii) of said step e) are implemented for a plurality of mesh points (Mₖ) at a depth of less than 2 cm or less than 1 cm.

13. Recording medium on which a computer program is recorded, comprising program code instructions for the execution of steps in the method according to claim 1, said instructions being executable on a microprocessor.

14. Multi-element ultrasound probe comprising a plurality of elementary transducers (1₁ . . . 1_{N}), each elementary transducer being capable of emitting and/or detecting an ultrasound wave, wherein said probe being comprises a microprocessor that can implement the test method according to claim 1.
